(19) United States
(12) Patent Application Publication
(10) Pub. No.: US 2006/0225116 A1
(43) Pub. Date: Oct. 5, 2006

(54) Thin network server

(75) Inventor: John William (Jack) Chaney, Gilroy, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/100,240

(22) Filed: Apr. 5, 2005

(51) Int. Cl. H04N 7/173; H04N 7/16

(52) U.S. Cl. 725/114; 725/144; 725/115; 725/91; 725/100

(57) ABSTRACT

A low cost server (thin server) for ATSC terrestrial broadcaster delivered services, replaces the conventional STB for delivering services to consumers. In one version, the server is for a network that has a sink device and one or more signal processing functions. The server has a receiver that receives a source signal; a network interface for connecting the sink device to the network; and a controller that provides the received source signal to the sink device via the network. When necessary the source signal is processed using a processing function in the network to enable the sink device to properly utilize the source signal.

### FIELD OF THE INVENTION

The present invention relates to servers for networks, and more particularly to thin servers for home networks.

### BACKGROUND OF THE INVENTION

A network generally includes a communication link and various devices with communication capability connected to the communication link. The devices include computers, peripheral devices, routers, storage devices, consumer electronics and appliances with processors and communication interfaces. An example of a network is a home network for a household in which various devices are interconnected. A usual household can contain several devices including personal computers and home devices such as consumer electronics and appliances that are typically found in the home. As such the term “device” generally includes logical devices or other units having functionality and an ability to exchange data, and can include not only all home devices but also general purpose computers.

Home devices include such electronic devices as security systems, theater equipment, consumer electronics (e.g., HDTVs, VCRs, DVD players, stereo equipment, direct broadcast satellite services (DBSS), digital satellite services (DSS), etc.), and the like. For example, such home devices can include support for networking using e.g. 1394 standard and communication protocols such as HTTP and HTML standards for inter-device communication and operation.

In one example conventional home network shown in FIG. 1, a sink device such as a high definition TV (HDTV) 12 is connected to a source device such as DSS 14 which provides digital programming to the HDTV via an IEEE-1394 network. The HDTV includes a decoder 11 and a display 13. The network 10 further includes a set-top-box (STB) 15 having a tuner 17 and a decoder 16 that decodes the signals from the DSS for the HDTV 12. Each decoder 11, 16 is designed to decode a certain format (e.g., MPEG2, MPEG4, etc.) from the DSS 14.

Conventionally, when a new video service is established, it is delivered to a customer's TV 12 via the STB 15. The conventional STB 15 provides a tuner, decoder, Conditional Access (CA) and Electronic Program Guide (EPG) functions in a single enclosure. The consumer connects the STB's input to the signal source and its output to the TVs baseband inputs. The STB is also known as the Integrated Receiver Decoder (IRD).

The need for this type of STB as an IRD in terms of satellite service providers is limited because digital networks, such as CEA-2027 over 1394, provide features that can allow multiple incremental enhancements without disjointing the User Interface. Conventional STBs include components that are unnecessary for processing received digital broadcasts.

There is, therefore, a need for a low cost server for Advanced Televisions Standards Committee (ATSC) terrestrial broadcaster delivered services that replaces conventional STBs for delivering services to the consumer.

### BRIEF SUMMARY OF THE INVENTION

The present invention addresses the above needs. In one embodiment, the present invention provides a low cost server (thin server) for ATSC terrestrial broadcaster delivered services, replacing the conventional STB for delivering services to consumers. In one version, the server is for a network that includes a sink device and one or more signal processing functions. The server includes a receiver that receives a source signal; a network interface for connecting the sink device to the network; and a controller that provides the received source signal to the sink device via the network, wherein when necessary the source signal is processed using a processing function in the network to enable the sink device to properly utilize the source signal.

The controller can include a selector, such that if the sink device is not capable of properly utilizing the source signal, the selector selects a signal processing function in the network that enables the sink device to properly utilize the source signal. In another version, when necessary the controller utilizes said signal processing function in the network to enable the source device to utilize the source signal. Further, when necessary the controller can switch the sink device to utilize said signal processing function to enable the sink device to utilize the source signal.

In one example, the source signal comprises an encoded signal, such that when necessary a decoding function in the network decodes the encoded source signal such that sink device can utilize the decoded source signal. In another example, the network further includes a tuner function such that when necessary the tuner function enables the sink device to utilize the source signal. A signal processing function is provided by a device that is connected to the network when necessary to provide said signal processing function.

In another version of the server, the server is provided by the network bus. Further, power for the server can provided by another device in the network. The network can comprise a CEA-2027 over 1394 network, and the controller can utilizes the XHTML protocol in the network.

In another aspect, the present invention provides a network that includes said server and a sink device, wherein the server provides signals to the sink device.

Other embodiments, features and advantages of the present invention will be apparent from the following specification taken in conjunction with the following drawings.

### BRIEF DESCRIPTION OF THE DRAWINGS

FIG. 1 shows an example functional block diagram of a conventional network.

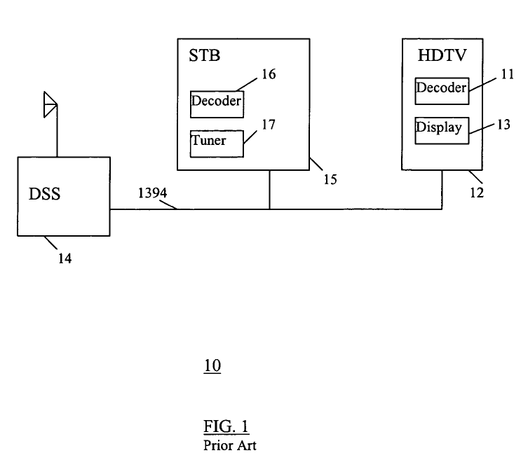

FIG. 2 shows an example function block diagram of an embodiment of a network according to the present invention with a thin server.

FIG. 3 shows an example function block diagram of another embodiment of a network according to the present invention with a thin server.

FIG. 4 shows an example function block diagram of another embodiment of a network according to the present invention which with a thin server, illustrating an example connectivity diagram for an NIU device, MPEG4 decoder device and HDTV device.

### DETAILED DESCRIPTION OF THE INVENTION

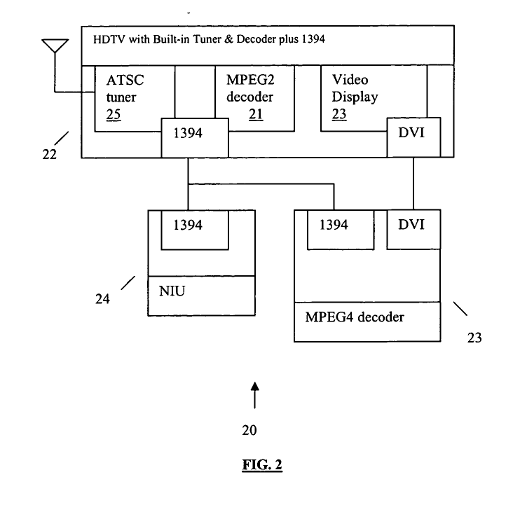

FIG. 2 shows a functional block diagram of an embodiment of a network 20 in which the present invention is implemented. The example network 20 comprises an IEEE-1394 network including a sink device such as a high definition TV (HDTV) 22 receiving digital programming signals via an antenna, a decoder 23 including an MPEG4 decoder, and a thin server 24 including a Network Interface Unit (NIU). The HDTV 22 includes an MPEG2 decoder 21, a display 23 and an ATSC tuner 25. The server 24 includes a 1394 input, and the HDTV 22 and the decoder 23 include DVI and 1394 inputs.

In one example, the decoder 23 is added into the network 20 using said method of transparent addition of features to network devices, to provide MPEG4 decoding capability which the HDTV 22 could not provide. This transparent addition of features to network devices, yields a STB functionality that allows a very thin server form factor 24 according to an embodiment of the present invention, for new pay services that are delivered by ATSC terrestrial broadcasters (e.g., EMMIS, USDTV, All Connect TV, etc.). These are services that supply additional video in terrestrial broadcaster's transmissions. These additional streams may have different properties than the conventional ATSC program transmission. The conventional ATSC transport stream is an MPEG System Level Multiplex but it has additional restrictions such as free, unencrypted, MPEG2 encoded, and one of 18 prescribed formats.

FCC regulations have affected the Television Manufacturing Industry in the mandate to have ATSC tuners in TVs and the mandate to have 1394 with DTCP link protection on Cable STBs. In order to accommodate these new services, according to the embodiments of the present invention it is only necessary to supply any missing functionality within the very thin server 24. In particular, the server 24 can use the ATSC tuner 25 and the MPEG2 decoder 21 from the HDTV 22.

Additional NIU functions that may need to be supplied in the network 20 are the Conditional Access function, possibly the EPG function and the User Interface function. The service provider may apply different compression techniques to the additional programs in its service mix in order to conserve bandwidth. To accommodate this in the network 20, a decoder function such as the decoder 23 must be supplied as described above. The decoder 23 is in the form of an additional “different compression” decoder connected to the DVI input of the HDTV 22.

As a result, new ATSC MPEG2 pay services may be delivered using a server 24 having an NIU without the need for a tuner, decoder, etc., because such functions already in the HDTV 22. As such, the server 24 can comprise a CPU, memory and a 1394 input (1394 I/O device). Power can provided to the server 24 from the 1394 bus, from the HDTV 23, etc. This type of service delivery has a considerable economic advantage over competitors services delivered by conventional STB type IRDs.

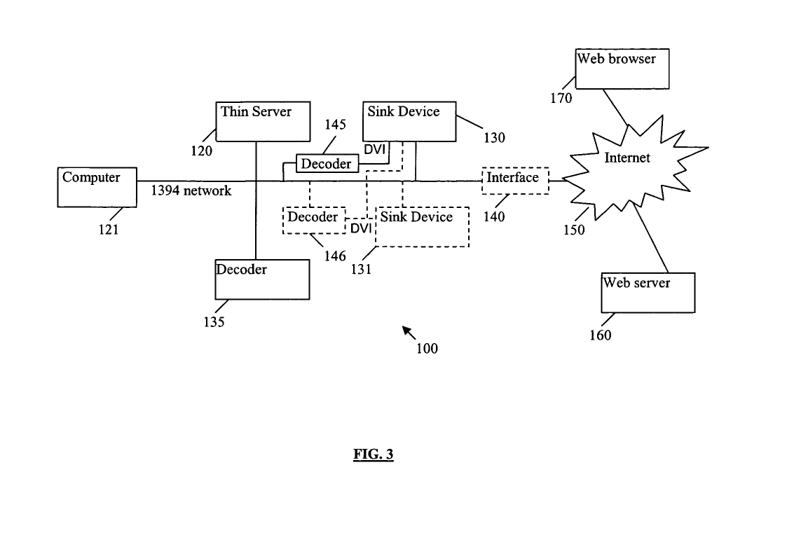

FIG. 3 shows an example functional architecture of another network 100, such as a home network, that implements an embodiment of the present invention. The network 100 comprises a thin server 120 according to the present invention that can include an NIU as a source of encoded digital satellite services, a computer 121, sink devices 130 (e.g., HDTV), and optional interface 140 that connects the network 10 to the Internet 150, the web server 160 and the web browser 170.

The network 100 further includes a decoder 135 that decodes signals from a source device 120 for a sink device 130. The sink and source devices can implement a client-server protocol, using e.g. HTTP protocol and XHTML (Extended HTML) for communication therebetween. In one example, the sink and source devices can communicate via the TCP/IP network protocol in a 1394 network.

The network 100 further allows addition of a second decoder 145 to decode other signals from the thin server 120 for a sink device 130. For example, if the decoder 135 is designed for decoding MPEG2 format signals and the server 120 beings to provide MPEG4 format signals, then the decoder 145 which is capable of MPEG4 format signals can be added to the network 100, rather than replacing the decoder 135 with another decoder that also provides MPEG4 decoding. A method of providing multiple incremental enhancements is described in commonly assigned patent application Ser. No. 10/921,693, filed on Aug. 18, 2004, titled: “A method and System for Transparent Addition of Features to Network Devices,” incorporated herein by reference.

Then, when the server 120 provides MPEG2 encoded signals, the decoder 135 is used to decode the MPEG2 signals for the sink 130, and when the server 120 also provides MPEG4 encoded signals, the decoder 145 is used to decode the MPEG4 signals for the sink 130. The sink device 130 is effectively upgraded to also decode the MPEG4 encoded services. This provides costs savings and ease of use. The system is distributed and new functionality (e.g. MPEG4 decoding) is added incrementally as needed without the need for inclusion of such addition needed functionality (e.g., MPEG4 decoding) in the server 120. Further, where the sink device 130 comprises a TV (e.g., TV 22 in FIG. 2), the tuner in the TV is used instead of the need for a tuner in the server 120.

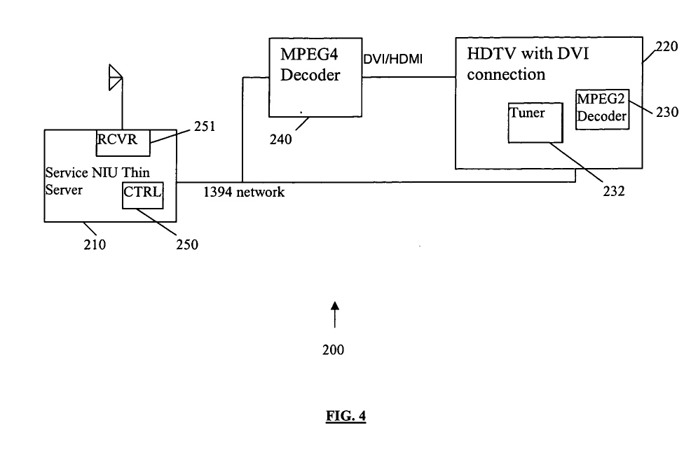

FIG. 4 shows another example embodiment of a network 200 according to the present invention, utilizing the IEEE 1394 network protocol, comprising a service NIU thin server 210 as a source of digital satellite services that provides MEPG2 and MPEG4 coded signals, an HDTV 220 that includes a tuner 232 and an MPEG2 decoder 230 for decoding the MPEG2 coded signal from the NIU 210, and an MPEG4 decoder 240 that has been connected to the DVI port of the HDTV 220 to decode the MPEG4 signals from the NIU 210.

The 1394 network digital interface is used to connect the NIU 210 to the HDTV 220. The interface provides digital signals in a manageable compressed form and can include digital networking protocols that allow components to communicate back and forth to simplify the operation of the entire network with minimum commands from users.

The HDTV 220 includes a digital video interface (DVI) port to which the MPEG4 decoder 240 is attached. DVI is a digital port designed to relay uncompressed digital signals from the NIU 210 to the HDTV 220 for display. An enhanced form of DVI is high definition multimedia interface (HDMI) used between any audio/video source, such as a set-top box, DVD player, or A/V receiver, and an audio or video monitor, such as a HDTV. HDMI supports standard, enhanced or high-definition video, and multi-channel digital audio on a single cable. An advantage of HDMI is that when the individual devices are enabled, a single remote control can operate devices in a home network. HDMI covers the conversion of video formats such that signals on a PC can be properly relayed for display on a TV monitor, for example. As such, the HDTV 220 can include an HDMI port to which the MPEG4 decoder 240 is connected.

The MPEG4 decoder 240 has been added to provide new service user interface for the MPEG4 signal from the NIU 210, as if the MPEG4 decoder 240 were internally placed and connected to the NIU 210. Because the MPEG2 system level transport is the same or similar to MPEG4, the NIU 210 remains the same device that delivers MPEG2 services, and now also delivers MPEG4 services.

The switching between the external MPEG4 decoder 240 and the internal MPEG2 decoder 230 (based on the type of signal to be decoded) is handled transparently by matching device capabilities from the NIU source 210 to proper decoder (decoder 230 or decoder 240) in a network connection manager built into the HDTV 220. This allows incrementally improving functionality of the network rather than requiring the NIU 210 to include such additional functionality (e.g., MPEG4 decoding).

In this example, the HDTV 220 utilizes the XHT protocol (XHTML 1.0 The Extensible HyperText Markup Language) to transparently add features to the HDTV 220. The NIU 210 can be configured (or include a controller 250) to perform the switching by sending the MPEG4 signals to the MPEG4 decoder 240 that is attached to the DVI port (e.g., HDMI port) of the HDTV 220 for decoding. The XHT protocol services the user interface for the MPEG4 decoder 240 as necessary.

In an example, a DSS signal is received by a receiver 251 in the NIU 210, wherein the DSS signal is sent from the NIU 210 to the HDTV 220 via the 1394 network for display. If the DSS signal is in MPEG2 format, then the MPEG2 signal is sent to the MPEG2 decoder 230 in the HDTV 1394 network for decoding the MPEG2 encoded signal and display by the HDTV 220. However, if the DSS signal is in MPEG4 format, then that signal is sent to the MPEG4 decoder 240 over the 1394 network to the MPEG4 decoder 240 for decoding, wherein the decoded signal is provided from the MPEG4 decoder to the HDTV 220 for display via the DVI port of the HDTV 220.

The DVI (or HDMI) input of the HDTV 220 allows adding additional processing devices to the HDTV 220 via the DVI port, wherein the NIU 210 is informed of the new processing. The NIU 210 can selectively switch (route) source signals from the NIU 210 to the MPEG4 decoder 240 for decoding, wherein the decoded signal is provided to the HDTV 220 by the MPEG4 decoder 240 via the DVI port of the HDTV 220. The recognition and switching can also implemented in the HDTV 220 or other network devices.

The switching of the HDTV 220 to receive decoded signals from the MPEG2 decoder 230 or the MPEG4 decoder 240, can be performed by the NIU 210 through a connection to switch the signal input to the HDTV from the 1394 network input to the DVI port of the HDTV 220 (preferably, transparent to the user of a HDTV 220).

Because the service NIU 210 is usually the device that provides the Electronic Program Guide (EPG) Data and tracks the correspondence between the data stream Program Identifiers (PIDs) for Audio and Video and the actual service channel (e.g., CNN Headline News), the NIU 210 has easy access to the data that indicates how the data channels are compressed (e.g., MPEG2, MPEG4, etc.). The NIU 210 can switch the HDTV 220 between the output of the MPEG4 decoder 240, and the output of the MPEG2 decoder 230 internal to the HDTV 220 using the CEA-931-B Select A/V Input Function command with the proper 1-byte argument that is established at setup time. The argument of that command is an unsigned byte value in the range 0 to 255. The exact values that the NIU 210 should use is a function of how the output of the MPEG4 decoder 240 is connected to the HDTV 220. Usually this will be either by DVI or by (Y, Pr, Pb). A one time dialog will generally be required at setup to establish the proper switching values. Subsequently, the switching happens automatically and will be transparent to the user.

The recognition and switching can be implemented e.g. in software or firmware as an XHT recognition application that is running on the NIU 210. An application that would perform a control function from one device to another using CEA-931-B HTTP commands is described in the CEA-2027 and CEA-931-B specifications (known by those skilled in the art). The XHT controller 250 is capable of appearing as an overlay on top of both DVI sourced video and 1394 sourced video and generally independent from the video source.

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. The aforementioned example architectures above according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A server for a network that includes a sink device and one or more signal processing functions, the server comprising:
a receiver that receives a source signal;
a network interface for connecting the sink device to the network; and
a controller that provides the received source signal to the sink device via the network, wherein when necessary the source signal is processed using a processing function in the network to enable the sink device to properly utilize the source signal.

2. The server of claim 1, wherein the controller includes a selector, such that if the sink device is not capable of properly utilizing the source signal, the selector selects a signal processing function in the network that enables the sink device to properly utilize the source signal.

3. The server of claim 1, wherein when necessary the controller utilizes said signal processing function in the network to enable the source device to utilize the source signal.

4. The server of claim 1, wherein when necessary the controller switches the sink device to utilize said signal processing function to enable the sink device to utilize the source signal.

5. The server of claim 1, wherein the source signal comprises a video signal.

6. The server of claim 1, wherein the source signal comprises an encoded signal, such that when necessary a decoding function in the network decodes the encoded source signal such that sink device can utilize the decoded source signal.

7. The server of claim 1, wherein the network further includes a tuner function such that when necessary the tuner function enables the sink device to utilize the source signal.

8. The server of claim 1, wherein the network comprises a 1394 network.

9. The server of claim 1, wherein the signal processing function is provided by a device that is connected to the network when necessary to provide said signal processing function.

10. The server of claim 1, wherein power for the server is provided by the network bus.

11. The server of claim 1, wherein power for the server is provided by another device in the network.

12. The server of claim 1, wherein the source signal is received from a ATSC terrestrial broadcaster.

13. The server of claim 1, wherein the source signal is received from an extraterrestrial broadcaster.

14. The server of claim 1, wherein the source signal comprises a digital signal.

15. The server of claim 1, wherein the server is used in place of an Integrated Service Device in the network.

16. The server of claim 1, wherein the network comprises a CEA-2027 over 1394 network.

17. The server of claim 1, wherein the controller utilizes the XHTML protocol in the network.

18. A network, comprising:
a sink device; and
a server comprising:
a receiver that receives a source signal;
a network interface for connecting the sink device to the network; and
a controller that provides the received source signal to the sink device via the network, wherein when necessary the source signal is processed using a processing function to enable the sink device to properly utilize the source signal.

19. The network of claim 18, wherein the controller includes a selector, such that if the sink device is not capable of properly utilizing the source signal, the selector selects a signal processing function in the network that enables the sink device to properly utilize the source signal.

20. The network of claim 18, wherein when necessary the controller utilizes said signal processing function to enable the source device to utilize the source signal.

21. The network of claim 18, wherein when necessary the controller switches the sink device to utilize said signal processing function to enable the sink device to utilize the source signal.

22. The network of claim 18, wherein the source signal comprises a video signal.

23. The network of claim 18, wherein the source signal comprises an encoded signal, such that when necessary a decoding function in the network decodes the encoded source signal such that sink device can utilize the decoded source signal.

24. The network of claim 18, wherein the network further includes a tuner function such that when necessary the tuner function enables the sink device to utilize the source signal.

25. The network of claim 18, wherein the network comprises a 1394 network.

26. The network of claim 18, wherein the signal processing function is provided by a device that is connected to the network when necessary to provide said signal processing function.

27. The network of claim 18, wherein power for the server is provided by a network bus.

28. The network of claim 18, wherein power for the server is provided by another device in the network.

29. The network of claim 18, wherein the source signal is received from a ATSC terrestrial broadcaster.

30. The network of claim 18, wherein the source signal is received from an extraterrestrial broadcaster.

31. The network of claim 18, wherein the server provides a network interface unit function in the network.

32. The network of claim 18, wherein the server is used in place of an Integrated Service Device in the network.

33. The network of claim 18, wherein the network comprises a CEA-2027 over 1394 network.

34. The network of claim 18, wherein the controller utilizes the XHTML protocol in the network.
